(19) United States
(12) Patent Application Publication
(10) Pub. No.: US 2017/0250593 A1
(43) Pub. Date: Aug. 31, 2017

(54) ELECTRIC GENERATOR, FOUNDATION PEDESTAL FOR ELECTRIC GENERATOR, AND MAINTENANCE METHOD FOR ELECTRIC GENERATOR

(71) Applicant: KABUSHIKI KAISHA TOSHIBA, Minato-ku (JP)

(72) Inventors: Kento ARAI, Kawasaki (JP); Hideyuki NAKAMURA, Tokyo (JP); Kiyoshi MIYAIKE, Yamato (JP); Yuichiro GUNJI, Yokohama (JP); Shinya NAKAYAMA, Yamato (JP); Toru KIKUCHI, Yokohama (JP); Kazuki SATO, Kawasaki (JP)

(73) Assignee: KABUSHIKI KAISHA TOSHIBA, Minato-ku (JP)

(21) Appl. No.: 15/445,346

(22) Filed: Feb. 28, 2017

(30) Foreign Application Priority Data
Feb. 29, 2016 (JP) 2016-037702

(51) Int. Cl. H02K 15/00; B65G 7/04; B65G 7/06; H02K 5/26; H02K 5/00

(52) U.S. Cl. CPC H02K 15/0006; H02K 5/26; H02K 5/00; B65G 7/06; B65G 7/04

(57) ABSTRACT

According to one embodiment, a maintenance method includes providing the electric generator with leg plates for placing the electric generator on a floor face of a foundation pedestal, forming a bottom portion of the electric generator to have a bottom plane capable of supporting a weight of the electric generator, and forming a gap between the bottom plane of the electric generator and an opposing floor face of the foundation pedestal; and providing the carrier device in the gap, and lifting up and horizontally moving the electric generator by the carrier device, and thereafter doing maintenance of the electric generator.

### CROSS-REFERENCE TO RELATED APPLICATIONS

This application is based upon and claims the benefit of priority from Japanese Patent Application No. 2016-037702, filed Feb. 29, 2016, the entire contents of which are incorporated herein by reference.

### FIELD

Embodiments described herein relate generally to an electric generator, a foundation pedestal for an electric generator, and a maintenance method for an electric generator.

### BACKGROUND

Single-shaft type combined cycle power plants which drive a single electric generator by a gas turbine and a steam turbine include a form in which the gas turbine and the steam turbine are connected via a single shaft with the electric generator located therebetween.

For the maintenance of an electric generator, a rotor is pulled out of a stator of the electric generator, and the rotor and the stator undergo internal inspection and repair. At this time, a space for pulling out the rotor in the axial direction is required on one axial end side of the electric generator. However, for the electric generator connected with engines at its both ends as above, a space for pulling out the rotor cannot be obtained due to the presence of the engines at both of its ends. As such, there is a drawback that one of the engines, i.e., the gas turbine or the steam turbine, must be disassembled at the time of the maintenance of the electric generator.

Relating to the maintenance of an electric generator connected with engines at both of its axial ends, a method that does not require disassembly of the engines (hereinafter called a “first method”) is known. According to this first method, a temporary work floor is constructed above either engine, the electric generator is lifted up by a portal crane, and the rotor of the electric generator is pulled out onto the temporary work floor to conduct inspection of the electric generator.

Also, relating to the maintenance of an electric generator connected with engines at both of its axial ends, another method that does not require disassembly of the engines (hereinafter called a “second method”) is known. According to this second method, a platform is provided above the steam turbine, then the electric generator is lifted up to the level of the platform by a temporary gantry crane, etc., then the electric generator is placed on a temporary support column, and the rotor is pulled out onto the platform to conduct inspection of the electric generator.

Also, relating to the maintenance of an electric generator connected with engines at both of its axial ends, a further method that does not require disassembly of the engines (hereinafter called a “third method”) is known. According to this third method, the electric generator is raised with a jack to form a gap between it and a foundation pedestal, the foundation for the electric generator is provided with a temporary rail in an axially perpendicular direction, a wheeled dolly to run on the rail is placed at the lower portion of the electric generator, the electric generator is laterally moved to the position where pulling of the rotor of the electric generator does not interfere with the engine, and thereafter the rotor is pulled out to conduct the maintenance of the electric generator.

The first method and the second method involve many auxiliary operations for the maintenance of an electric generator, such as installation of a temporary work floor (platform) and a temporary crane, and as such, they incur additional costs and work time and also create a problem of safety due to high uplift of the electric generator. Furthermore, providing the temporary work floor (platform) above the steam turbine leads to a problem of posing limitations on the maintenance of the steam turbine.

Also, the third method involves many auxiliary operations for the axially perpendicular movement of the electric generator, such as jacking up the electric generator, installation of the temporary rail and attachment of the wheeled dolly, and as such, it incurs additional costs and work time and also creates a problem of increasing items to be checked for safety relating to, for example, strength of the temporary rail onto which a load is concentrated.

In view of the foregoing, techniques that allow safe maintenance operations while reducing the maintenance costs and work time for an electric generator are desired.

### BRIEF DESCRIPTION OF THE DRAWINGS

FIG. 1 is a side view showing a shafting structure of a single-shaft type combined cycle power plant (combined-cycle power plant) adopting an electric generator driven at both ends according to one embodiment;

FIG. 2 is a side view showing a structure of the electric generator according to the same embodiment;

FIG. 3 is a bottom view showing one example of a bottom structure of the electric generator in the same embodiment;

FIG. 4 is a bottom view showing another example of the bottom structure of the electric generator in the same embodiment;

FIG. 5 is a bottom view showing another example of the bottom structure of the electric generator in the same embodiment;

FIG. 6 is a side view for description of one example of a maintenance method for the electric generator according to the same embodiment;

FIG. 7A and FIG. 7B are a side view and a bottom view showing a structure of a carrier device used in the same embodiment (where carriers of an air float type are adopted);

FIG. 8 is a sectional view for description of an operation principle of the air float-type carriers used in the same embodiment;

FIG. 9 is a top view for description of one example of the maintenance method for the electric generator according to the same embodiment;

FIG. 10 is a front view for description of one example of the maintenance method for the electric generator according to the same embodiment;

FIG. 11 is a front view for description of another example of the maintenance method for the electric generator according to the same embodiment;

FIG. 12 is a sectional view showing one example of a structure of a carrier device guide used in the same embodiment;

FIG. 13A and FIG. 13B are a side view and a top view showing a modification example of a structure of a foundation pedestal according to the same embodiment;

FIG. 14A and FIG. 14B are a side view and a top view showing a modification example of the structure of the electric generator according to the same embodiment;

FIG. 15 is a side view for description of a modification example of the maintenance method for the electric generator according to the same embodiment;

FIG. 16 is a side view showing a modification example of the carrier device (carrier device of the combination of an air-pressure or water-pressure or oil-pressure lift-up mechanism and a dolly with rollers) used in the same embodiment;

FIG. 17 is a side view showing another modification example of the carrier device (carrier device of the combination of an air-pressure or water-pressure or oil-pressure lift-up mechanism and rollers) used in the same embodiment; and

FIG. 18 is a top view showing another modification example of the maintenance method for the electric generator according to the same embodiment.

### DETAILED DESCRIPTION

Hereinafter, embodiments will be described with reference to the drawings.

In general, according to one embodiment, there is provided a maintenance method for an electric generator applied to a power plant in which both axial ends of the electric generator are connected to respective rotary machines. The maintenance method includes: providing the electric generator with leg plates for placing the electric generator on a floor face of a foundation pedestal, forming a bottom portion of the electric generator to have a bottom plane capable of supporting a weight of the electric generator, and forming a gap between the bottom plane of the electric generator and an opposing floor face of the foundation pedestal such that a carrier device capable of lifting up and horizontally moving the electric generator can be inserted into the gap while the electric generator is placed on the floor face of the foundation pedestal via the leg plates; and providing the carrier device in the gap, lifting up and horizontally moving the electric generator by the carrier device, and thereafter doing maintenance of the electric generator.

First, a shafting structure of a plant including an electric generator as an inspection target will be described.

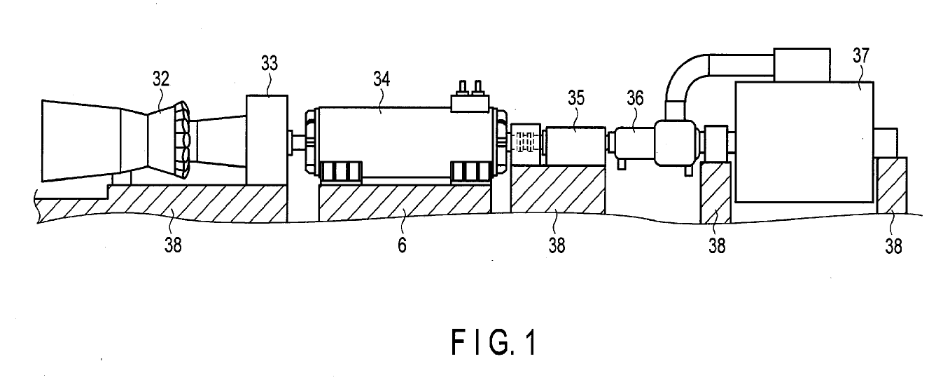

FIG. 1 is a side view showing the shafting structure of a single-shaft type combined cycle power plant (combined-cycle power plant) adopting an electric generator driven at both ends according to one embodiment.

This plant is a combined-cycle power plant which drives an electric generator by a gas turbine and a steam turbine, wherein a gas turbine 32, and a medium-to-high pressure steam turbine 36 and a low pressure steam turbine 37 are disposed at the respective ends of an electric generator 34, connected to each other via an intermediate shaft 33, a clutch 35, or the like, and linearly arranged on one axis as shown in FIG. 1. Also, the gas turbine 32, the medium-to-high pressure steam turbine 36, the low pressure steam turbine 37, and the electric generator 34 are each installed on foundation pedestals 38 and 6 made of, for example, reinforced concrete, as shown in FIG. 1.

Note that, in the following descriptions, the direction that is perpendicular and horizontal to the rotational axis of the electric generator will be called a “lateral direction”.

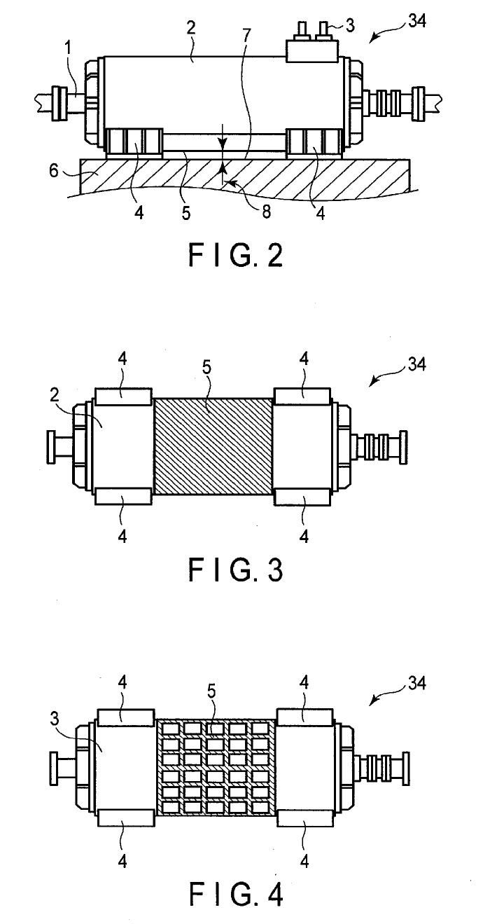

FIG. 2 shows the structure of the electric generator according to this embodiment.

Generally, there are various forms for an electric generator to take, regarding the extracting direction of a terminal for extracting generated electric power, the arrangement of a cooler, the distance (center height) from the level of a foundation pedestal for installation of leg plates to the center of the axis of a rotor, and so on. In this embodiment, since the electric generator 34 is moved in the lateral direction only with a slight uplift, it is a prerequisite to have a structure that does not cause the main structure of the electric generator 34, such as a terminal 3, a cooler, and a frame, to interfere with the foundation pedestal during the movement in the lateral direction. FIG. 2 is drawn as one example of the electric generator 34 that satisfies such a prerequisite, and the extracting direction of the terminal 3 is the area above the electric generator.

The electric generator 34 is placed on the foundation pedestal 6 using leg plates 4 arranged at four corners, and secured by means of foundation bolts and key structures (omitted in the figures). A bottom plane 5 of the electric generator 34, which is surrounded by the leg plates 4 at the four corners of the electric generator 34, is at a position higher than the bottom face of the leg plates 4 and forms a gap 8 between it and a floor face 7 of the foundation pedestal when the electric generator 34 is viewed from the lateral direction.

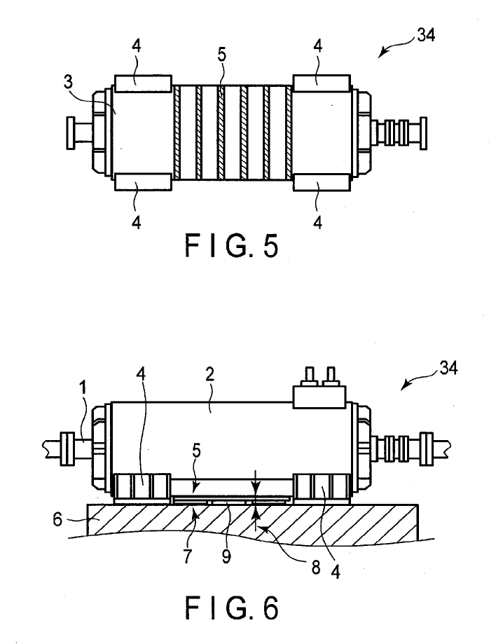

FIGS. 3 to 5 show examples of the bottom plane 5 of the electric generator 34 when viewed from below.

The bottom plane 5 of the electric generator is for evenly transferring the electric generator's own weight to a carrier device (described later). Thus, as shown by hatched lines in FIGS. 3 to 5, the bottom plane 5 may be formed with a flat plate structure or as non-continuous structural faces in a grid pattern or a shelf plate pattern.

When conducting maintenance with such structures, a carrier device 9 is inserted from the side into the gap 8 formed between the bottom plane 5 of the electric generator and the floor face 7 of the foundation pedestal as shown in FIG. 6. The carrier device 9 is a device capable of lifting up and horizontally moving the electric generator 34. The carrier device 9 shown in FIG. 6 is an example of the carrier device in which carriers of an air float type are adopted.

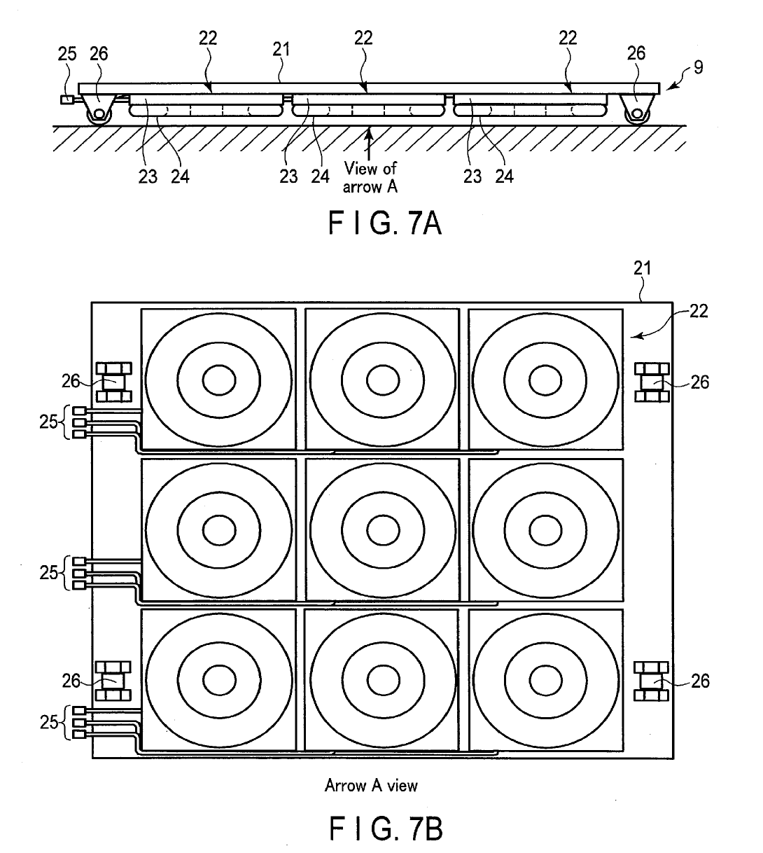

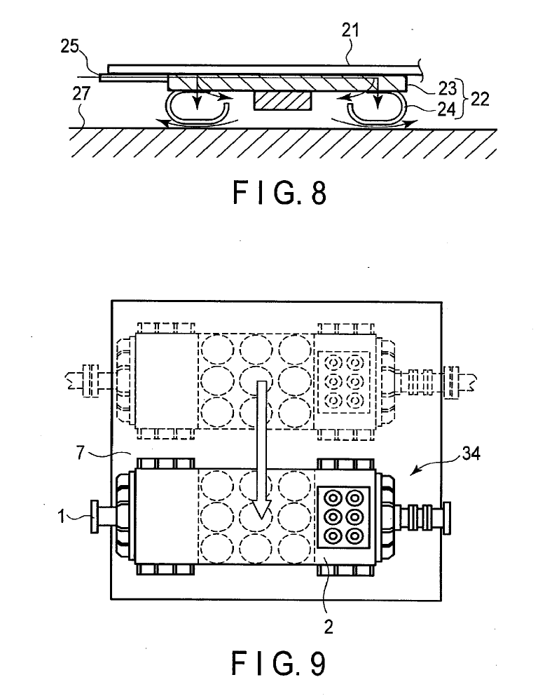

FIG. 7A and FIG. 7B show one example of the carrier device adopting air float-type carriers. FIG. 7A is a side view and FIG. 7B is a bottom view (view seen from the direction of arrow A that is in the middle of FIG. 7A). Also, FIG. 8 shows an operation principle of the air float-type carriers. Note that the arrows in FIG. 8 represent flows of compressed air.

The carrier device 9 shown in FIG. 6 has a structure in which a plurality of air float-type carriers 22 are fixed under a load-receiving plate 21 as shown in FIG. 7A and FIG. 7B, and which includes casters 26 that contact the ground during the non-actuation of compressed air.

The air float-type carrier 22 includes mainly a base 23 and a bag 24, and lifts up the load loaded upon base 23 using the air pressure in the bag created by supplying compressed air from an air supply port 25 to the inside of the bag 24. At this time, a thin film of air is formed between the bag 24 and a floor face 27, providing an advantage that a frictional force during the carriage is very small. There is also an advantage that the height of the carrier device 9 can be lowered.

The gap 8 formed between the bottom plane 5 of the electric generator and the floor face 7 of the foundation pedestal is larger than the height of the carrier device 9 during the non-actuation of compressed air by the carrier device 9. This allows easy insertion of the carrier device 9 into the gap 8 by means of the casters 26 attached to the carrier device 9, without an operation of jacking up the electric generator 34.

Note that both ends of the rotor axis of the electric generator 34 should be disconnected from other rotor axes in advance, and structural elements of the electric generator should be disconnected from structural elements of the foundation in advance. Also, the pipe arrangement of the electric generator, structural elements of the foundation, etc., that would interfere with the electric generator 34 at the lateral movement should be disassembled.

Additionally, the piping of the electric generator should be formed into a structure that can be easily disassembled in order to avoid interference with the lateral movement; for example, a flange connection at the same level of the floor face 7 of the foundation pedestal may be adopted, or a flanged short pipe may be provided at the level of the floor face 7 of the foundation pedestal. For also the structural elements of the foundation, such as a foundation bolt, a stud structure protruding upward beyond the floor face 7 of the foundation pedestal should be eliminated and a foundation bolt having a tap on the side of the foundation pedestal 6 and being screwed from above the leg plates 4 may be adopted, and the members that would interfere with the electric generator 34 during the lateral movement, such as an excitation bus bar standing from below the foundation pedestal 6, should be formed into a structure that can be easily disassembled.

Next, air pressure is actuated for the carrier device 9 to lift up the electric generator 34 and to bring the leg plates 4 into a state of floating above the foundation pedestal 6.

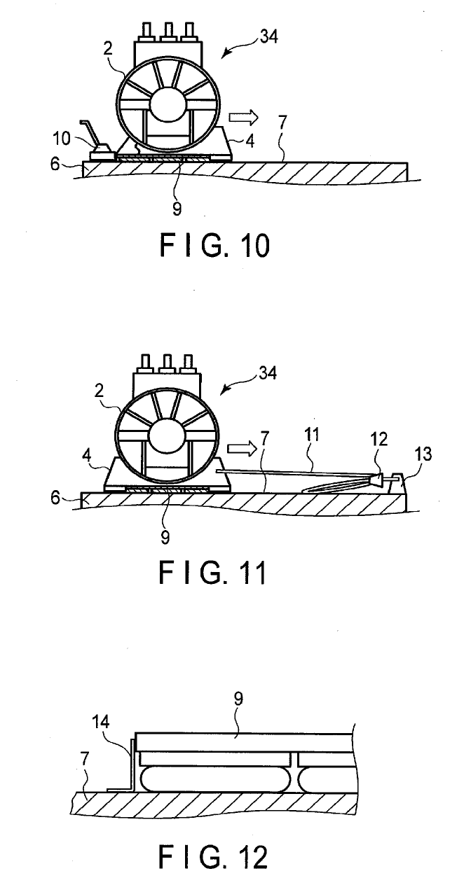

Thereafter, the electric generator 34 is moved in the lateral direction over the floor face 7 of the foundation pedestal by the carrier device 9 as shown in FIG. 9. Two examples of the method for the lateral movement of the electric generator 34 are shown in FIG. 10 and FIG. 11. FIG. 10 shows an example in which a carrier drive device 10 associated with the carrier device 9 is adopted. FIG. 11 shows an example in which a chain block 12 and wire 11 are adopted between the electric generator 34 and an anchor 13 of the foundation pedestal, as the motive power for the lateral movement. Other methods such as one using a winch or a crane may also be taken.

At the lateral movement, providing a movement guide 14 for the carrier device as shown in FIG. 12 or a stopper would improve the workability and safety. This movement guide 14 or stopper may be provided on the floor face of the foundation pedestal on a permanent basis, or provided only for the work time by means of fastening, etc.

After the lateral movement to the position where a rotor 1 can be pulled out without interfering with other equipment, the electric generator 34 is lowered by discharging the air pressure of the carrier device 9 and is placed on the foundation pedestal 6 via the leg plates 4. At this position, disassembly of the electric generator 34 and maintenance operations including taking out the rotor are conducted.

The respective steps of the maintenance operations of the electric generator 34 described above are summarized as follows:
An axis disconnection step to disconnect the rotary machines at the respective axial ends of the electric generator 34;
A foundation disconnection step to disconnect the foundation pedestal 6 for the electric generator 34 from the leg plates 4;
A disassembly step to disassemble, on the side of the electric generator 34 and the side of the foundation pedestal 6, structural elements that would cause interference between the electric generator 34 and the foundation pedestal 6 during the axially perpendicular movement of the electric generator 34;
A carrier device insertion step to insert the carrier device 9 into the gap 8;
A carriage step to lift up the electric generator 34 by the actuation of the carrier device 9 and laterally move the electric generator 34 over the floor face 7 of the foundation pedestal to a predetermined position; and
An electric generator placement step to place the electric generator 34 at the predetermined position on the foundation pedestal 6 via the leg plates 4.

After completing the maintenance operations for the electric generator 34, the electric generator 34 can be returned to its original position by carrying out the respective steps described as the pre-maintenance steps above in a reverse manner. In this instance, the pressure for the carrier device 9 is actuated again for the uplift and the lateral movement of the electric generator 34. After the electric generator 34 is returned to the given installation position, the pressure of the carrier device 9 is discharged, and the electric generator 34 is installed at the given position on the foundation pedestal 6 via the leg plates 4 and connected to the rotary machines at the respective axial ends.

For this re-installation of the electric generator 34, alignment between the rotor axes to be connected and the respective ends of the electric generator 34 needs to be adjusted. In this task, vertical adjustment is performed by varying the thickness of shims inserted under the leg plates 4, and the horizontal position of the electric generator 34 is finely adjusted. In any case, however, jacking up the electric generator 34 would be required. In the embodiment, the uplift function of the carrier device 9 may also be utilized for this work, and thus, the electric generator 34 can be installed while performing the alignment adjustment without a changeover after the lateral movement of the electric generator 34. In other words, the carrier device 9 itself can be utilized as a jacking device for the electric generator 34 for the alignment adjustment task, so the necessity of setting up a new jacking device can be eliminated and the efficiency in re-installation operations can be achieved.

According to this embodiment as above, preparation for the movement of the electric generator is completed only by inserting the carrier device 9 into the gap 8 formed between the electric generator 34 and the foundation pedestal 6, without lifting up (jacking up) the electric generator 34, and the electric generator 34 can be easily moved. Since a temporary crane or a work cradle for lifting up the electric generator 34, or installation work for the temporary equipment for the lateral movement of the electric generator 34 is not required, the maintenance costs and work time can be reduced. Moreover, with the smaller amount of uplift of the electric generator 34, operational safety is improved, too. Also, the weight of the electric generator 34 during carriage is received over a wide area of the floor face 7 of the foundation pedestal, so the load on the foundation pedestal 6 can be mitigated, also contributing to the reduction in basic costs during the construction.

### MODIFICATION EXAMPLE 1

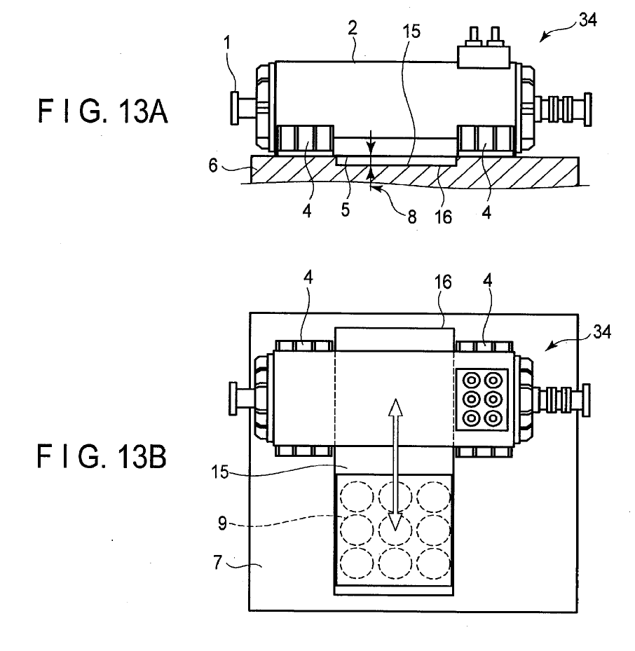

Next, a modification example 1 of the above embodiment will be described with reference to FIG. 13A and FIG. 13B.

FIG. 13A and FIG. 13B are a side view and a top view mainly showing the modification example of the structure of the foundation pedestal 6.

In the embodiment described above, the gap 8 between the bottom plane 5 of the electric generator and the floor face 7 of the foundation pedestal is provided by forming the bottom plane 5 of the electric generator to be higher than the bottom face of the leg plates 4. In contrast, in the modification example 1 shown in FIG. 13A and FIG. 13B, the gap 8 is provided by forming a floor face 15 of the foundation pedestal, located at the corresponding portion, to be lower than the floor face 7 of the foundation pedestal where the leg plates 4 are placed. That is, the floor face of the foundation pedestal at the position facing the bottom plane 5 of the electric generator is made lower than the floor face of the foundation pedestal for the placement of the leg plates 4.

Also, this low floor face 15 of the foundation pedestal is formed as the underside of a groove 16 having a width in the axial direction of the electric generator which is equal to or greater than the width of the carrier device 9, and having a length in the axially perpendicular direction of the electric generator which assumes the movement range of the electric generator 34 and the size, etc., of a drive mechanism associated with the carrier device.

When conducting maintenance with such a structure, the carrier device 9 is positioned within the groove 16 and inserted below the bottom plane 5 of the electric generator 34, and then the electric generator 34 is lifted up and moved in the lateral direction to a predetermined position by the carrier device 9 in the groove 16.

According to this modification example, the height of the center of the rotational axis of the electric generator 34 from the floor face 7 of the foundation pedestal (so-called center height) can be made lower than in the above-described embodiment by the amount of the gap. Also, since the side faces of the groove 16 may serve as a movement guide or a stopper for the movement of the carrier device, the need to provide a separate movement guide or stopper can be eliminated. Together, as the movement face for the carrier device is defined, there is also an advantage that a smooth floor face required for the carrier device can be easily formed and maintained.

### MODIFICATION EXAMPLE 2

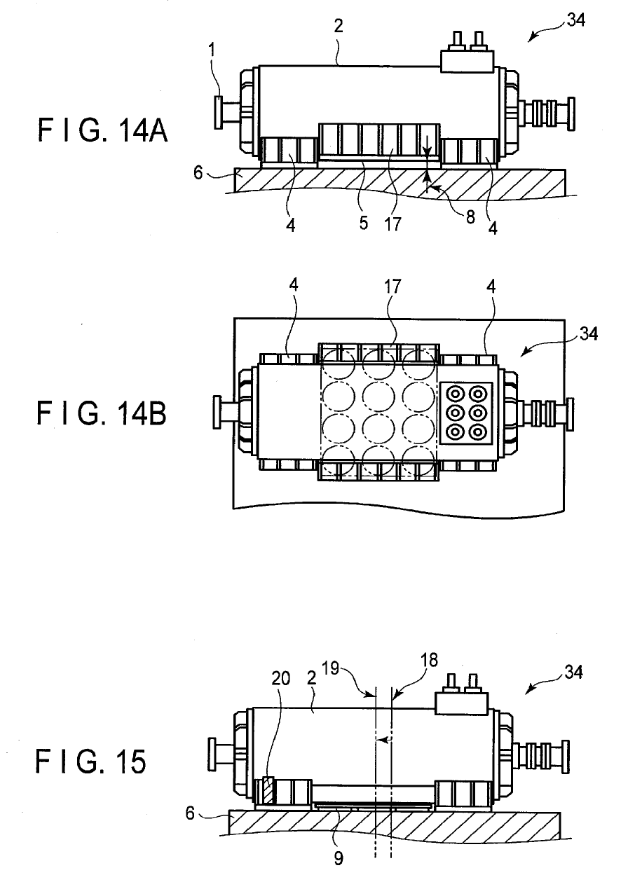

Next, a modification example 2 of the above embodiment will be described with reference to FIG. 14A and FIG. 14B.

FIG. 14A and FIG. 14B are a side view and a top view mainly showing the modification example of the structure of the electric generator 34.

In the first embodiment described above, the load capacity of the carrier device 9 depends on the surface area of the bottom plane 5 of the electric generator, so if the electric generator has a large weight for the surface area of the bottom plane 5 of the electric generator, the carrier device 9 would lack a sufficient load capacity. In such an instance, a load-receiving extension rack 17 for extending the area of the bottom plane 5 of the electric generator in the axially perpendicular direction of the electric generator (constituting a plane flush with the bottom plane 5 of the electric generator) is added to the side face of the stator 2 of the electric generator, as shown in FIG. 14A and FIG. 14B.

The load-receiving extension rack 17 may be formed integrally with the stator 2 of the electric generator or as a separate member attached by means of fastening, etc., to the stator 2 of the electric generator.

According to this modification example, providing the load-receiving extension rack 17 can suitably extend the area of the bottom plane 5 of the electric generator. Therefore, the load restriction of the carrier device 9 can be eliminated and the design margin of the carrier device can be increased. Together, the weight of the applicable electric generator 34 can be increased.

### MODIFICATION EXAMPLE 3

Next, a modification example 3 of the above embodiment will be described with reference to FIG. 15.

FIG. 15 is a side view showing the modification example of the maintenance method for the electric generator 34.

In the first embodiment described above, when the electric generator 34 is laterally moved, the carrier device 9 supports the electric generator 34. Depending on a structure of the electric generator 34 or a form of the movement, a central axis 18 of the electric generator which corresponds to the center of gravity of the electric generator 34 may shift from a central axis 19 of the carrier device which corresponds to the center position (load-receiving center) of the carrier device 9. In such an instance, an uneven load may be applied to the carrier device 9 and the intended performance might not be achieved.

Accordingly, it is effective to approximate the central axis 19 of the carrier device to the central axis 18 of the electric generator by adjusting the axial position of the carrier device 9; however, dimensional constraints on the carrier device 9, the electric generator 34, or the foundation may not allow a sufficient adjustment. To deal with this, it is possible to adjust the position of the central axis 18 of the electric generator by disassembling part of the components of the electric generator 34 to reduce the load before operating the carrier device 9, but as another method, it is also possible to add a necessary counter weight 20 to the electric generator as shown in FIG. 15 to approximate the central axis 18 of the electric generator to the central axis 19 of the carrier device and equally distribute the load onto the carrier device.

According to this modification example, when the center of gravity of the electric generator 34 and the load-receiving center of the carrier device 9 are deviated beyond a tolerable value, the central axis 18 of the electric generator and the central axis 19 of the carrier device can be approximated to each other by adjusting the center of gravity of the electric generator 34 through the addition of the counter weight 20 to one end of the electric generator 34 or disassembly of part of the structure of the electric generator before the carriage operation. Therefore, the load on the carrier device 9 can be evenly distributed.

### MODIFICATION EXAMPLE 4

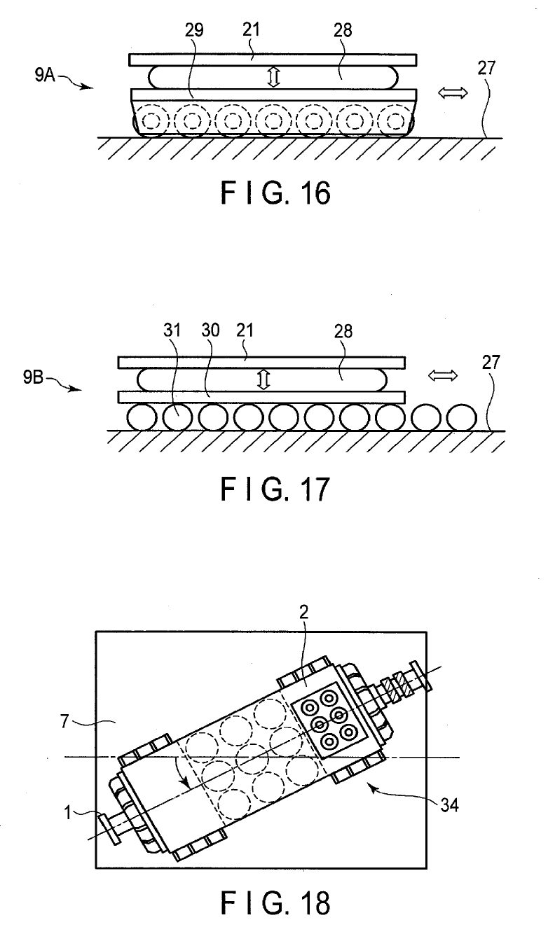

Next, a modification example 4 of the above embodiment will be described with reference to FIG. 16 and FIG. 17.

FIG. 16 is a side view showing a modification example of the carrier device 9 (carrier device of the combination of an air-pressure or water-pressure or oil-pressure lift-up mechanism and a dolly with rollers). Also, FIG. 17 is a side view showing a modification example of the carrier device 9 (carrier device of the combination of an air-pressure or water-pressure or oil-pressure lift-up mechanism and rollers).

As a carrier device for conducting maintenance operations, a carrier device 9A having an air-pressure or water-pressure or oil-pressure jack 28, and having a dolly 29 with rollers on which the jack 28 is mounted as shown in FIG. 16, or a carrier device 9B having rollers 31 on which jack 28 and a jack seating 30 for attachment of the jack 28 are also mounted as shown in FIG. 17 may be adopted, as well as the carrier device 9 using the air float-type carriers 22 as shown in FIG. 8 for the above first embodiment.

As described above, the air float-type carriers 22 cause the device to float due to a thin film of air, producing a very small frictional resistance during the lateral movement and providing the advantages of simplifying the drive mechanism and changeover for the lateral movement, and reducing the dimensions in the height direction as compared to other modes. However, the air float-type carriers 22 allow a relatively small load capacity. On the other hand, while the dimension in the height direction is increased, the modes to use a jack as shown in FIG. 16 and FIG. 17 can increase the load capacity by adopting, in particular, a pressure medium using water pressure or oil pressure.

### MODIFICATION EXAMPLE 5

Next, a modification example 5 of the above embodiment will be described with reference to FIG. 18.

FIG. 18 is a top view showing the modification example of the maintenance operations for the electric generator 34.

The above embodiment shows an example in which maintenance and inspection are conducted upon moving the electric generator 34 by the carrier device 9 in the lateral direction over the floor face 7 of the foundation pedestal as shown in FIG. 9. The maintenance and inspection for the electric generator 34 may be conducted not only upon the lateral movement, but also upon horizontal rotation as shown in FIG. 18 whereby the rotor 1 is pulled out and the rotor 1 and the stator 2 are subjected to internal inspection.

Note that the steps for the maintenance operations for the electric generator 34 in this modification example are the same as the steps in the above embodiment except the step to horizontally rotate the electric generator 34.

According to this modification example, the method of horizontally rotating the electric generator 34 can reduce the movement range of the electric generator 34. Therefore, the required sizes of the foundation pedestal and the floor face 7 of the foundation pedestal can also be reduced, contributing to the reduction in basic costs during the construction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made. The accompanying claims and their equivalents are intended to cover such forms or modifications as would fall within the scope of the inventions.

1. A maintenance method for an electric generator applied to a power plant in which both axial ends of the electric generator are connected to respective rotary machines, the maintenance method comprising:
providing the electric generator with leg plates for placing the electric generator on a floor face of a foundation pedestal, forming a bottom portion of the electric generator to have a bottom plane capable of supporting a weight of the electric generator, and forming a gap between the bottom plane of the electric generator and an opposing floor face of the foundation pedestal such that a carrier device capable of lifting up and horizontally moving the electric generator can be inserted into the gap while the electric generator is placed on the floor face of the foundation pedestal via the leg plates; and
providing the carrier device in the gap, and lifting up and horizontally moving the electric generator by the carrier device, and thereafter doing maintenance of the electric generator.

2. The maintenance method according to claim 1, wherein part or whole of the gap is formed by forming the bottom plane of the electric generator to be higher than a bottom face of the leg plates.

3. The maintenance method according to claim 1, wherein part or whole of the gap is formed by forming the floor face of the foundation pedestal which faces the bottom plane of the electric generator to be lower than the floor face of the foundation pedestal where the leg plates are disposed.

4. The maintenance method according to claim 3, further comprising forming a groove at the floor face of the foundation pedestal which faces the bottom plane of the electric generator, the groove having a width equal to or greater than a width of the carrier device in the axial direction of the electric generator.

5. The maintenance method according to claim 1, further comprising forming the electric generator not to have a structure which interferes with the foundation pedestal during the horizontal movement of the electric generator, or forming the electric generator to have a component which interferes with the foundation pedestal to be in an easily detachable structure.

6. The maintenance method according to claim 1, further comprising forming the foundation pedestal not to have a structure which interferes with the electric generator during the horizontal movement of the electric generator, or forming the foundation pedestal to have a component which interferes with the electric generator to be in an easily detachable structure.

7. The maintenance method according to claim 1, further comprising providing a load-receiving extension rack to a side face of the electric generator, the load-receiving extension rack extending an area of the bottom plane of the electric generator in an axially perpendicular direction of the electric generator.

8. The maintenance method according to claim 1, further comprising: an axis disconnection step to disconnect the rotary machines at the respective axial ends of the electric generator; a foundation disconnection step to disconnect the leg plates from the foundation pedestal for the electric generator; a disassembly step to disassemble, on a side of the electric generator and a side of the foundation pedestal, structural elements which cause interference between the electric generator and the foundation pedestal during the horizontal movement of the electric generator; a carrier device insertion step to insert the carrier device into the gap; a carriage step to lift up the electric generator by actuation of the carrier device and horizontally move the electric generator over the floor face of the foundation pedestal to a predetermined position; and an electric generator placement step to place the electric generator at the predetermined position on the foundation pedestal via the leg plates.

9. The maintenance method according to claim 1, further comprising forming the carrier device to have an air-float type carrier capable of using air pressure to carry an item via an air film, and have a caster to rest upon during non-actuation of air pressure.

10. The maintenance method according to claim 1, further comprising forming the carrier device to have an air-pressure or water-pressure or oil-pressure jack, and have a dolly with rollers on which the jack is mounted.

11. The maintenance method according to claim 1, further comprising forming the carrier device to have an air-pressure or water-pressure or oil-pressure jack, and have rollers arranged under a seating for attachment of the jack.

12. The maintenance method according to claim further comprising providing a movement guide or a stopper to limit a movement range of the carrier device during the horizontal movement of the electric generator by the carrier device.

13. The maintenance method according to claim 1, further comprising returning the electric generator to an original position by performing the respective steps in a reverse manner after maintenance of the electric generator, and adjusting alignment of the electric generator to the rotary machines at the respective axial ends using an uplift function of the carrier device.

14. The maintenance method according to claim 8, further comprising adding a counter weight to one end of the electric generator or disassembling part of the electric generator before the movement of the electric generator by the carrier device, so as to reduce a shift between a center of gravity of the electric generator and a load-receiving center of the carrier device.

15. An electric generator of which both axial ends are connected to respective rotary machines, the electric generator comprising:
leg plates for placing the electric generator on a floor face of a foundation pedestal; and
a bottom plane capable of supporting a weight of the electric generator at a bottom portion;
wherein a gap is formed between the bottom plane of the electric generator and an opposing floor face of the foundation pedestal such that a carrier device capable of lifting up and horizontally moving the electric generator can be inserted into the gap while the electric generator is placed on the floor face of the foundation pedestal via the leg plates.

16. The electric generator according to claim 15, wherein part or whole of the gap is formed by forming the bottom plane of the electric generator to be higher than a bottom face of the leg plates.

17. The electric generator according to claim 15, wherein a structure to interfere with the foundation pedestal is absent during the horizontal movement of the electric generator, or a component which interferes with the foundation pedestal is formed to be in an easily detachable structure.

18. The electric generator according to claim 15, further comprising a load-receiving extension rack to extend an area of the bottom plane of the electric generator in an axially perpendicular direction of the electric generator.

19. A foundation pedestal for an electric generator of which both axial ends are connected to respective rotary machines, the foundation pedestal comprising:
a floor face for placing the electric generator,
wherein a gap is formed between a bottom plane of the electric generator and the floor face of the foundation pedestal which faces the bottom plane of the electric generator such that a carrier device capable of lifting up and horizontally moving the electric generator can be inserted into the gap while the electric generator is placed on the floor face of the foundation pedestal via leg plates.

20. The foundation pedestal according to claim 19, wherein part or whole of the gap is formed by forming the floor face of the foundation pedestal which faces the bottom plane of the electric generator to be lower than the floor face of the foundation pedestal where the leg plates are disposed.

21. The foundation pedestal according to claim 19, wherein a groove is formed at the floor face of the foundation pedestal which faces the bottom plane of the electric generator, the groove having a width equal to or greater than a width of the carrier device in a horizontal direction in which the electric generator moves.

22. The foundation pedestal according to claim 19, wherein a structure which interferes with the electric generator is absent during the horizontal movement of the electric generator, or a component which interferes with the electric generator is formed to be in an easily detachable structure.
